(19) United States
(12) Patent Application Publication
(10) Pub. No.: US 2026/0307632 A1
(43) Pub. Date: Oct. 8, 2026

(54) METHOD OF OPERATING A SERVICE BRAKE IN RELATION TO AN AXLE OF A VEHICLE

(71) Applicant: ZF CV Systems Global GmbH, Bern (CH)

(72) Inventors: Robin Szymanski, Hannover (DE); Marvin-Lucas Zoch, Hannover (DE); Ulrich Brockmeyer, Gronau OT Banteln (DE); Thorsten Averbeck, Geesthacht (DE); Andreas Marx, Seelze (DE)

(21) Appl. No.: 19/480,544

(22) PCT Filed: Apr. 16, 2024
(86) PCT No.: PCT/EP2024/060279

§ 371 Date: Oct. 31, 2025

(30) Foreign Application Priority Data
May 3, 2023 (DE) 10 2023 111 426.3

(51) Int. Cl. B60T 8/1761; B60T 8/171; B60T 8/172; B60T 8/1763; B60T 8/1766

(52) U.S. Cl. CPC B60T 8/1761; B60T 8/171; B60T 8/172; B60T 8/1763; B60T 8/1766; B60T 2210/12; B60T 2240/00

(57) ABSTRACT

A method (100) for operating a service brake (210) in relation to an axle (205) in order to brake a wheel (215) of an axle (205) of a vehicle (200a), in particular a utility vehicle (200b), having a further axle (205′) which is different from the axle (205) accounts for a change in road conditions. The method (100) includes recording (110) an input variable (260) relating to the further axle (205′) and ascertaining (120) a control variable (270) relating to the axle on the basis of the input variable (260) relating to the further axle (205′). The method includes outputting (130) a control signal (280) for changing a braking variable (211) of the service brake (210), taking into account the control variable (270) relating to the axle.

### FIELD

The present disclosure relates to a method for operating a service brake in relation to an axle in order to brake a wheel of an axle of a vehicle, in particular a utility vehicle, having a further axle which is different from the axle. The present disclosure also relates to a computer program and/or computer-readable medium, a control unit for a vehicle, in particular a utility vehicle, and a vehicle, in particular a utility vehicle.

### BACKGROUND

Braking systems for vehicles having an anti-lock braking system (ABS) are known from the prior art. The braking system is designed to exert a braking torque on a wheel or multiple wheels of the vehicle in order to decelerate the vehicle. The ABS reduces or prevents the locking of a wheel braked by the braking system by reducing a brake pressure and may therefore improve a braking procedure as well as the driving safety.

ABS are known, which record the wheel speed of the wheel to be braked and, in the event of too abrupt a change in speed, cause a reduction in the brake pressure in order to avoid or end any locking of the wheel.

Furthermore, centrally controlled braking systems are known, which enable a braking force distribution and/or vehicle dynamics control, for example using input signals from a yaw sensor.

DE 10 2018 123 996 A1 discloses an at least two-channel electro-pneumatic central pressure control module, designed as a structural unit, for an electro-pneumatic service brake device of a vehicle, having at least two pressure control channels, which can be electrically controlled with regard to a brake pressure. It is provided here that a central electronic brake control unit has a circuit board which supports electric and electronic components, wherein routines at least for the brake pressure control and for the vehicle dynamics control are implemented in the electric and electronic components, wherein at least one inertial sensor is arranged on or in the at least one circuit board and is connected in an electrically conductive manner to at least some of the electronic and electronic components on the circuit board such that the output signals of the at least one inertial sensor can be fed into the at least some electric and electronic components for the purpose of carrying out the vehicle dynamics control. Optionally, ABS pressure control valves may also be connected between the central pressure control module as a “central module” and brake cylinders at wheels of a first axle and a second axle, which ABS pressure control valves enable the brake pressure in these brake cylinders to be controlled in a wheel-specific manner.

The ABS pressure control valves here are controlled by the central electronic brake control unit. An anti-lock braking system of a wheel of an axle according to the prior art controls the braking of the wheel on the basis of information which relates to the wheel and/or the axle itself, possibly influenced by an input signal of the central control unit.

Such control of an ABS, however, may result in a repeated axle load transfer and a corresponding movement of a driver's cab of the vehicle, in particular with certain friction properties of the roadway or ground and particular vehicle configurations.

The ABS here may excite a vibration mode of the vehicle through a repeated axle load transfer. The vibration mode here may result in a repeated, for example periodic, shift in the axle load. This may be unpleasant for a driver and/or occupants of the vehicle. Moreover, a normal force acting between the wheels and the ground changes repeatedly.

An axle load shift during braking with an ABS may result in a significant loss of traction, i.e. a comparatively abrupt and significant slip at one or more wheels, owing to a periodically rising and falling normal force on the wheels of the vehicle or axles of the vehicle, for example.

If the axle load shift is comparatively great, this may cause pressure control devices to be too slow to reduce a brake pressure in a brake chamber such that the locking of one or more wheels may be prevented.

A further problem may arise in the form of a μ-jump scenario (friction-jump scenario). The μ-jump scenario describes a transition from a ground surface with a comparatively high friction coefficient or friction value between a wheel and the ground to a ground surface with a comparatively low friction coefficient between the wheel and the ground.

For an ABS, when braking the vehicle in such a μ-jump scenario, the challenge is to adapt the brake pressure abruptly to the change in the friction coefficient. For example, if the ground changes from asphalt to ice, the brake pressure should be abruptly reduced in order to ensure the driving stability. In the opposite case, the brake pressure should be abruptly increased to achieve an improved braking performance.

Furthermore, it can be observed that, for example, ABS pressure control valves are subject to increasingly high demands in terms of cost-effectiveness. In this regard, an improvement to the control of an ABS may compensate the repercussions of such demands and/or nevertheless improve the effect of the ABS.

### SUMMARY

The present disclosure is therefore based on the object of enhancing the prior art. One embodiment achieves the object of providing an improved vehicle stability and/or reducing an axle load transfer and/or reducing movements of a driver's cab and therefore improving the safety and comfort, even in a u-jump scenario.

Said object is achieved by a method according to present disclosure and the subject matters described herein

According to one aspect of the present disclosure, a method for operating a service brake in relation to an axle in order to brake a wheel of an axle of a vehicle, in particular a utility vehicle, having a further axle which is different from the axle, is provided. The method comprises: recording an input variable relating to the further axle; ascertaining a control variable relating to the axle on the basis of the input variable relating to the further axle; and outputting a control signal for changing a braking variable of the service brake, taking into account the control variable relating to the axle.

The vehicle, in particular the utility vehicle, is referred to below as vehicle. The method is therefore a method for controlling the service brake of the vehicle. The vehicle has a plurality of axles, namely at least the axle and the further axle. For example, the axle is designed as a rear axle and the further axle is designed as a front axle.

In order to operate the service brake, the input variable relating to the further axle is recorded as an input variable external to the axle. The input variable here may be a wheel of the further axle, the further axle, a variable relating to the wheel of the further axle and/or to drive components and/or brake components associated with the further axle. The input variable may be recorded by sensors and/or via communication technology, for example via a vehicle bus. The input variable may comprise a plurality of different pieces of information. Comprehensive characterization for variables which are potentially relevant for braking the wheel of the axle is thus possible.

The control variable relating to the axle may be ascertained on the basis of the input variable relating to the further axle. The control variable here is a variable which relates to the axle having the wheel to be braked and/or to the wheel of the axle that is to be braked. The control variable here may relate to the control for the braking of the wheel and/or the wheels of the axle. In other words, the control variable may be, in particular, a control variable relating to a wheel, in particular in the case of wheel-specific control of the braking. It has been recognized here that, from properties and/or features of the further axle which may influence the driving dynamics and/or driving stability, it is possible to infer corresponding properties and/or features of the axle.

Taking into account the control variable relating to the axle, the control signal for changing the braking variable of the service brake may be output. The braking variable here may be adjusted, for example, on the basis of the control variable. A predictable change to the control variable may be brought about by the control signal. The braking variable here may be a variable determining the braking torque of the wheel and/or the wheels of the axle which may be applied to the service brake as a result of the control signal.

As a result of processing the input variable relating to the further axle to provide the control variable relating to the axle, it is possible to use information across all axles within the vehicle. The method may therefore achieve control of the service brake across all axles. The service brake for one axle may therefore be calibrated or adjusted on the basis of the service brake of the other axle. Therefore, for example, an axle load transfer may be detected from the loss of traction of a wheel on the further axle, in order to intervene in the braking of the wheel of the axle.

Furthermore, the approach enables improved operation of the service brake in a u-jump scenario. In the case of a transition from asphalt to ice, for example, a loss of traction of a wheel on the front axle as a further axle may be used to control the braking at the rear axle as the axle as a preventative measure.

The present disclosure provides an approach which enables the wheel and/or the axle to be controlled by the service brake depending on information, data or variables which are not dependent, or are only indirectly dependent, on the control of the wheel and/or the axle, and instead relate to the further axle. It has been recognized here that such a variable may typically describe the vehicle dynamics, an environment and/or other circumstances and/or features, which may have an influence on the control of the service brake associated with the axle. Such an approach here may also be applied in relation to automated driving functions and/or applications for autonomous driving, since meaningful input variables are typically already recorded and/or processed by the vehicle here.

The method may be applied in a wheel-specific manner here, i.e. to only one wheel of the axle. Alternatively or in addition, the method may be applied to multiple wheels of the axle and/or for multiple wheels of an axle package including multiple axles.

Optionally, the service brake comprises an anti-lock braking system and the input variable indicates whether an ABS control of the service brake is taking place. It has been recognized here that, in particular, an intervention in the ABS control may bring about an improvement in the vehicle stability, since the ABS control may be the reason for a repeated axle load transfer and therefore a vibration of the vehicle, and/or the reaction of the service brake to the change in friction coefficients in the u-jump scenario when braking with ABS control may be improved, in particular by the control across all axles. Alternatively or in addition, the input variable comprises a slip of the wheel of the further axle, a wheel deceleration of the wheel of the further axle and/or a control signal for controlling a braking variable for braking the wheel of the further axle. It has been recognized here that, from the above-mentioned variables and their development over time, it is possible to derive whether a repeated axle load transfer is taking place and/or whether a μ-jump scenario is present in combination with an ABS control in each case.

Optionally, the control signal is output such that the braking variable remains constant or decreases when a normal force acting on the wheel of the further axle drops, and/or the braking variable increases when a normal force acting on the wheel of the further axle rises. A vibrating movement of the vehicle may thus be counteracted. A loss of traction of one or more wheels of the axle may be counteracted by maintaining or reducing the braking variable. The braking performance may be improved by increasing the braking variable if the friction value of the ground changes from a low friction value to a high friction value.

Optionally, on the basis of the input variable, a vibrating behavior and/or an axle load transfer of the vehicle is or are ascertained on the basis of the input variable and the control variable is ascertained taking into account the vibrating behavior and/or the axle load transfer. To this end, a development of the input variable over time is recorded and processed. For example, a vibration of the vehicle may be established from a Fourier transform or the like. If a vibration is established, the control variable may be adapted accordingly, for example likewise repeatedly, in order to suppress the vibration of the vehicle. It has been recognized here that the vibrating behavior and the axle load transfer each have an influence on the normal force acting between the wheel and the ground. If the weight of the vehicle shifts in the direction of the axle or if the axle load is transferred in the direction of the axle, the normal force typically rises, which may prevent locking of the wheel. If the weight of the vehicle shifts away from the axle or if the axle load is transferred away from the axle, the normal force typically drops, which may promote locking of the wheel. It has therefore been recognized that the axle load transfer and/or the vibrating behavior is a suitable, quantifiable and effectively ascertainable variable which may have an influence on the control of the service brake in order to improve the braking.

Optionally, the input variable comprises a friction coefficient between the wheel of the further axle and the ground. Therefore, the input variable may directly provide information about an expected friction coefficient for the wheel of the axle that is to be braked. Therefore, a prediction about a change in the friction coefficient can be taken into account during the control of the braking variable. To this end, the control variable optionally comprises a difference between the friction coefficient between the wheel of the further axle and the ground and a friction coefficient between the wheel of the axle and the ground.

Optionally, the control variable comprises a prediction of a friction coefficient between the wheel of the axle and the ground. On the basis of the prediction of the friction coefficient between the wheel of the axle and the ground, it is possible to take preventative measures for controlling the braking variable, in particular to avoid a loss of traction of the wheel and to thereby improve the vehicle stability and/or the braking performance.

According to one aspect of the disclosure, a computer program and/or a computer-readable medium is provided. The computer program and/or the computer-readable medium comprises/comprise commands which, when the program or the commands is or are executed by a computer, cause the latter to carry out the method according to the present disclosure and/or steps of said method. Optionally, the computer program and/or the computer-readable medium comprises/comprise commands which, when the program or the commands is or are executed by a computer, cause the latter to carry out the method steps described as being advantageous or optional, in order to achieve a technical effect associated therewith.

One aspect of the present disclosure provides a control unit of a vehicle, in particular a utility vehicle. The control unit here is designed to carry out the method described above. Optionally, the control unit is designed to carry out the method such that one or more of the features described as optional above are realized in order to achieve an associated technical effect.

According to one aspect of the present disclosure, a vehicle, in particular a utility vehicle, comprising a service brake with an anti-lock braking system and the control unit described above, is provided. The control unit here may have one or more features described as optional in order to achieve an associated technical effect.

### BRIEF DESCRIPTION OF THE DRAWINGS

Further advantages and features of the present disclosure as well as the technical effects thereof are revealed in the figures and the description of the preferred embodiments shown in the figures. In the figures:

FIG. 1 shows a schematic illustration of a vehicle, in particular a utility vehicle, according to one embodiment of the present disclosure ;

FIG. 2 shows a schematic illustration of a flow chart of a method according to one embodiment of the present disclosure ;

FIG. 3 shows a time series in each case of wheel speeds and brake pressures of a utility vehicle according to the prior art; and

FIG. 4 shows a time series in each case of wheel speeds and brake pressures and of a control signal of a utility vehicle according to one embodiment of the present disclosure.

### DETAILED DESCRIPTION

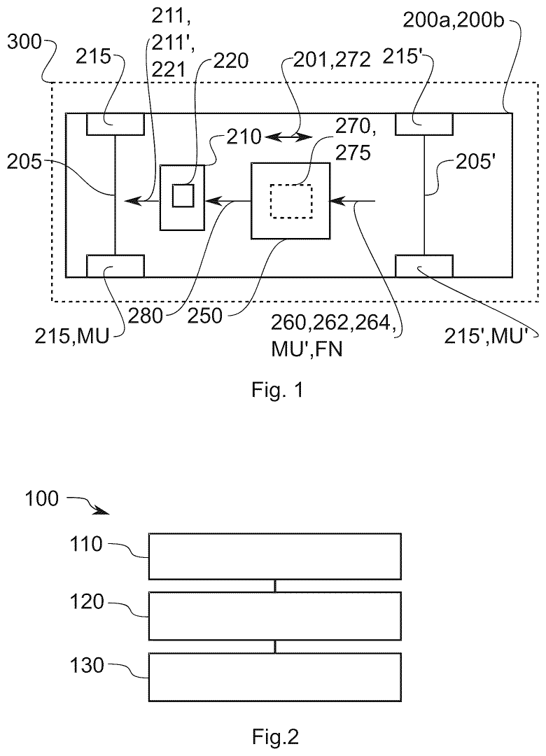

FIG. 1 shows a schematic illustration of a vehicle 200a, in particular a utility vehicle 200b, of one embodiment of the present disclosure.

The vehicle 200a, in particular the utility vehicle 200b, is referred to below as vehicle 200a, 200b. The vehicle 200a, 200b is a land vehicle, for example a traction engine of a multi-unit utility vehicle.

The vehicle 200a, 200b is positioned on the ground 300 in an environment. The ground 300 is, for example, a roadway with possibly locally varying features. The features of the ground 300 have an influence on a friction value or friction coefficient MU, MU′ and therefore the driving dynamics of the vehicle 200a, 200b and, in particular, the braking of the vehicle 200a, 200b.

The vehicle 200a, 200b includes multiple axles 205, 205′, for example two axles 205, 205′. The vehicle 200a, 200b includes a plurality of wheels 215, 215′ associated with the axles 205, 205′, for example two wheels 215, 215′ for each axle 205, 205′. In an embodiment which is not shown, the vehicle 200a, 200b has more than two axles 205, 205′ and/or the vehicle 200a, 200b has more than two, for example four, wheels 215, 215′ on at least one of the axles 205, 205′.

The vehicle 200a, 200b is positioned with the wheels 215, 215′ on the ground 300. That is to say the wheels 215, 215′ are in contact with the ground 300. The wheels 215, 215′ and the ground 300 are in operative contact with one another along a contact surface. The friction coefficient MU, MU′, which characterizes the contact between the respective wheel 215, 215′ and the ground 300, can be defined at the contact surface between the wheels 215, 215′ and the ground 300. The friction value MU, MU′ may be different for each of the wheels 215, 215′.

As a result of the contact between the wheels 215, 215′ and the ground 300, a normal force FN acts between the wheels 215, 215′ and the ground 300. The normal force FN here is perpendicular to the contact surface between the respective wheel 215, 215′ and the ground 300. In the case of a horizontally aligned roadway as the ground 300 and an idle vehicle 200a, 200b, the normal force FN may act, for example, in a vertical direction. The ground 300 may have a road gradient, i.e. the roadway as the ground 300 may have an upward and/or downward slope. The vehicle 200a, 200b has force sensors (not shown), which ascertain the normal force FN and/or a difference between a normal force FN in an idle position of the vehicle 200a, 200b and the normal force FN present. The force sensors may measure, for example, a force associated with a deflection of a component of a chassis of the vehicle 200a, 200b.

The vehicle 200a, 200b includes a service brake 210. The service brake 210 is a pneumatic, hydraulic and/or electro-mechanical brake. The service brake 210 is designed to achieve a braking effect for braking the vehicle 200a, 200b. To this end, the service brake 210 is designed to slow a movement of the wheels 215, 215′, or to control the slowing of the movement of the wheels 215, 215′. The service brake 210 may apply a braking variable 211, for example a braking torque, a braking force and/or a brake pressure, in order to decelerate the wheel(s) 215, 215′. A slip 262 and a wheel deceleration 264 are established at the wheels 215, 215′ as a result of the vehicle 200a, 200b being driven and/or braked.

The service brake 210 includes an anti-lock braking system 220. The anti-lock braking system 220 is designed to detect a locking tendency of the wheels 215, 215′ and to prevent locking of the wheels 215, 215′ and/or to reduce the locking tendency of the wheels 215, 215′. To this end, the anti-lock braking system 220 is designed to intervene in the braking and to reduce the braking variable 211 if, for example, a locking tendency is detected. The anti-lock braking system 220 is therefore designed to carry out an ABS control 221.

An axle load transfer 272 may take place as a result of the vehicle 200a, 200b being braked. With this, the vehicle 200a, 200b may tilt. For example, the vehicle 200a, 200b initially tilts forwards when braking. The chassis of the vehicle 200a, 200b is deflected forwards and rebounds rearwards here. With this, the normal force FN on the wheels 215 of the axle 205 designed as a front axle rises and the normal force FN on the wheels 215′ of the further axle 205′ designed as a rear axle drops. If the deceleration decreases, for example if there is a reduction in the braking variable 211, the chassis of the vehicle 200a, 200b is deflected rearwards and rebounds forwards. With this, the normal force FN on the wheels 215 of the axle 205 designed as a front axle drops and the normal force FN on the wheels 215′ of the further axle 205′ designed as a rear axle rises.

The vehicle 200a, 200b includes a control unit 250. The control unit 250 is designed to carry out the method 100 described with reference to FIG. 2.

The control unit 250 according to FIG. 1 is designed to record an input variable 260 relating to the further axle 205′. The input variable 260 relates to the further axle 205′ and/or the further wheels 215′ of the further axle 205′ or to a drive and/or braking system of the further axle 205′. The input variable 260 indicates whether ABS control 221 by the anti-lock braking system 220 of the service brake 210 is taking place. In addition or alternatively, the input variable 260 may be a slip 262 of the wheel 215′ of the further axle 205′, a wheel deceleration 264 of the wheel 215′ of the further axle 205′ and/or a control signal 211′ for controlling a braking variable 211′ for braking the wheel 215′ of the further axle 205′. In addition or alternatively to the wheel deceleration 264, the wheel speed 410 may be recorded using a speed sensor. To this end, the control unit 250 is connected to corresponding sensors and/or a vehicle bus (not shown). The control unit 250 may retrieve information relating to operating data of the vehicle 200a, 200b as an input variable 260 external to the axle, in particular via the vehicle bus.

The control unit 250 is designed to ascertain a control variable 270 relating to the axle on the basis of the input variable 260 relating to the further axle 205′. A vibrating behavior 201 and an axle load transfer 272 of the vehicle 200a, 200b are ascertained on the basis of the input variable 260. The control variable 270 is ascertained taking into account the vibrating behavior 201 and the axle load transfer 272. Therefore, starting with the input variable 260, it is possible to infer the development over time of normal forces FN and/or of slip 262 or wheel speeds 410 (see FIG. 4).

The control unit 250 is designed to output a control signal 280 to the service brake 210 in order to change the braking variable 211 of the service brake 210, taking into account the control variable 270 relating to the axle. The control signal 280 is output such that the braking variable 211 remains constant or decreases when a normal force FN acting on the wheel 215′ of the further axle drops, and/or the braking variable 211 increases when a normal force FN acting on the wheel 215′ of the further axle 205′ rises. Such a control signal 280 is shown in FIG. 4 and is described with reference to FIG. 4.

The control signal 280 is output such that the change to the braking variable 211 takes place alternatively or in addition to an ABS control 221 by the anti-lock braking system 220 and/or alternately therewith. The control signal 280 is output such that the change to the braking variable 211 and an ABS control 221 by the anti-lock braking system 220 are superimposed.

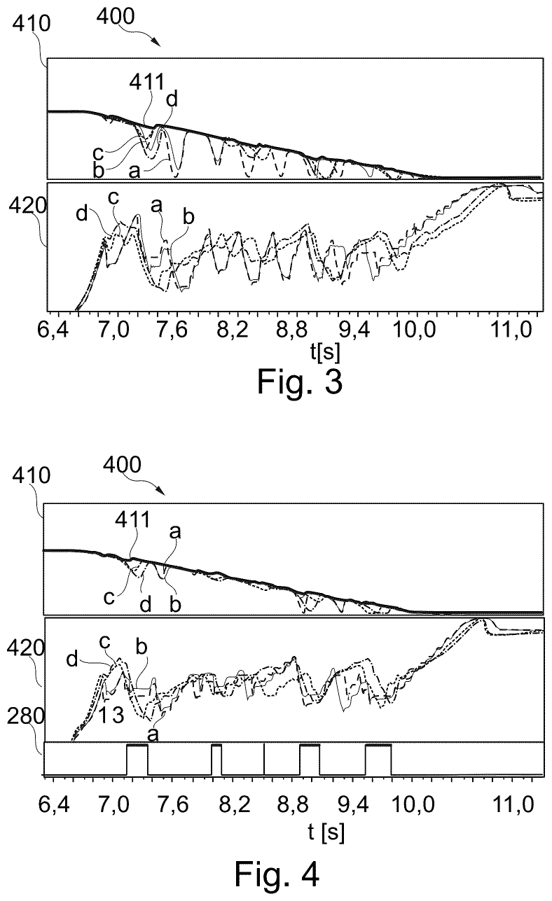

The vehicle 200a, 200b is furthermore designed to reduce and/or to avoid possible negative effects of an axle load transfer 272. A significant axle load transfer 272 may cause an abrupt loss of traction of a wheel 215, 215′, i.e. an undesirably high increase in the slip 262, for example due to a drop in the normal force FN acting on the wheel 215, 215′. If the axle load transfer 272 is too great, a braking system according to the prior art might not provide the required pressure decrease quickly enough and might therefore further reinforce the axle load transfer 272 (see FIG. 3).

The vehicle 200a, 200b according to FIG. 1 is designed to maintain or reduce the braking variable 211 for the front axle 205 if the further wheel 215′ of the further axle 205′, i.e. the rear axle, decelerates (see FIG. 4). Therefore, in the event of a subsequent axle load transfer 272 to the rear, a loss of traction of the wheel 215 of the front axle 205 may be counteracted. Alternatively or in addition, the control unit 250 is designed to calculate a model for the axle load transfer 272 and/or vibration properties 201, to predict the axle load transfer 272 and to change the braking variable 211 according to a prediction of the axle load transfer 272.

In another embodiment, the axle 205 may be designed as a rear axle and the further axle 205′ may be designed as a front axle.

The vehicle 200a, 200b finds itself in a u-jump scenario (friction jump scenario). In the u-jump scenario, the friction coefficient MU of the axle 205 is different from the friction coefficient MU′ of the further axle 205′. The friction coefficient MU′ of the further axle 205′ here may be ascertained on the basis of the input variable 260, for example. The control variable 270 includes a difference between the friction coefficient MU′ between the wheel 215′ of the further axle 205′ and the ground 300 and a friction coefficient MU between the wheel 215 of the axle 205 and the ground 300. in one aspect, the control variable 270 includes a prediction of a friction coefficient MU between the wheel 215 of the axle 205 and the ground 300.

In the μ-jump scenario, use is made of the fact that, during a forward movement of the vehicle 200a, 200b, the further axle 205′ designed as a front axle has already experienced a change in the friction coefficient MU′ relative to the friction coefficient MU of the axle 205 designed as a rear axle. Such a change in the friction coefficient MU will also occur at the rear axle 205. It is therefore possible to infer the future friction coefficient MU of the rear axle 205 from the difference between the friction coefficients MU, MU′. On the basis of this, the operation of the service brake 210 may be adapted in a preventative manner by the control signal 280. If a transition from a high friction coefficient MU, MU′ to a low friction coefficient MU, MU′ occurs, for example in the event of change in the roadway from asphalt to ice, the braking variable 211 may be maintained or reduced and/or an increase in the braking variable 211 may be reduced. If a transition from a low friction coefficient MU, MU′ to a high friction coefficient MU, MU′ occurs, for example in the event of a change in the roadway from ice to asphalt, the braking variable 211 may be increased.

The vehicle 200a, 200b is designed to carry out automated driving functions. The vehicle 200a, 200b may therefore gather information about the ground 300 along a trajectory to be driven from other vehicles which have already driven along the trajectory. A change to the roadway properties and, in particular, the friction values along the trajectory may be predicted on the basis of the data which are external to the vehicle and relate to the ground 300, and the braking variable 211 may be set on the basis of a prediction of the friction values along the trajectory.

FIG. 2 shows a schematic illustration of a flow chart for a method 100 according to one embodiment of the present disclosure. The method 100 is a method 100 for operating a service brake 210 in relation to an axle 205 in order to brake a wheel 215 of an axle 205 of a vehicle 200a, in particular a utility vehicle 200b, having a further axle 205′ which is different from the axle 205. Such a vehicle 200a, 200b is described with reference to FIG. 1. FIG. 2 is described with reference to FIG. 1.

According to FIG. 2, the method 100 includes: recording 110 an input variable 260 relating to the further axle 205′. The service brake 210 includes an anti-lock braking system 220 and the input variable 260 indicates whether ABS control 221 of the service brake 210 is taking place. In addition or alternatively, the input variable 260 may be a slip 262 of the wheel 215′ of the further axle 205′, a wheel deceleration 264 of the wheel 215′ of the further axle 205′ and/or a control signal for controlling a braking variable 211′ for braking the wheel 215′ of the further axle 205′. A vibrating behavior 201 and an axle load transfer 272 of the vehicle 200a, 200b are ascertained on the basis of the input variable 260.

The method 100 includes: ascertaining 120 a control variable 270 relating to the axle on the basis of the input variable 260 relating to the further axle 205′. The control variable 270 comprises a difference between the friction coefficient MU′ between the wheel 215′ of the further axle 205′ and the ground 300 and a friction coefficient MU between the wheel 215 of the axle 205 and the ground 300. The control variable 270 comprises a prediction of a friction coefficient MU between the wheel 215 of the axle 205 and the ground 300. The control variable 270 is ascertained taking into account the vibrating behavior 201 and the axle load transfer 272.

The method 100 includes: outputting 130 a control signal 280 for changing a braking variable 211 of the service brake 210, taking into account the control variable 270 relating to the axle. The control signal 280 is output such that the braking variable 211 remains constant or decreases when a normal force FN acting on the wheel 215′ of the further axle drops, and/or the braking variable 211 increases when a normal force FN acting on the wheel 215′ of the further axle 205′ rises.

FIG. 3 shows a time series 400 in each case of wheel speeds 410 and brake pressures 420 of a utility vehicle 200b according to the prior art. FIG. 3 is described with recourse to the concepts applied with reference to FIGS. 1 and 2.

The time series 400 in FIG. 3 are plotted as a function of time t in seconds. An upper part of FIG. 3 shows the wheel speeds 410 with indices a, b, c and d and a vehicle speed 411. A lower part of FIG. 3 shows the brake pressures 420 as braking variable 211 with indices a, b, c, and d.

The vehicle speed 411 is represented as a reference. The wheel speed 410 denoted by index a is the wheel speed 410 of a left wheel 215 of the axle 205 designed as a front axle. The wheel speed 410 denoted by index b is the wheel speed 410 of a right wheel 215 of the axle 205 designed as a front axle. The wheel speed 410 denoted by index c is the wheel speed 410 of a left wheel 215′ of the axle 205′ designed as a rear axle. The wheel speed 410 denoted by index d is the wheel speed 410 of a right wheel 215′ of the axle 205′ designed as a rear axle.

The brake pressure 420 denoted by index a is the brake pressure 420 of the left wheel 215 of the axle 205 designed as a front axle. The brake pressure 420 denoted by index b is the brake pressure 420 of the right wheel 215 of the axle 205 designed as a front axle. The brake pressure 420 denoted by index c is the brake pressure 420 of the left wheel 215′ of the axle 205′ designed as a rear axle. The brake pressure 420 denoted by index d is the brake pressure 420 of the right wheel 215′ of the axle 205′ designed as a rear axle.

According to the example of FIG. 3, the utility vehicle 200b is brought to a standstill from a vehicle speed 411 of 50 km/h by full application of the brake. ABS control 221 by the anti-lock braking system 220 of the service brake 210 takes place here. All of the wheels 215, 215′ experience significant slip at repeated and regular time intervals, which is shown in the upper part of FIG. 3 by a significant drop in the wheel speed 410 relative to the vehicle speed 411. In particular, the front axle 205 is affected particularly frequently and significantly. This can be attributed to the axle load shift or axle load transfer 272.

The front axle 205 is particularly affected, since the vehicle 200b is fully loaded. As a result, the normal force FN acting on wheels 215′ of the rear axle 205′ is higher than the normal force acting on the wheels 215 of the front axle 205. The wheels 215′ of the rear axle 205′ therefore experience greater slip 262.

The brake pressures 420 are shown in the lower part of FIG. 3. It can be seen here that the service brake 210 of the front axle 205 builds up a brake pressure 420 before the wheels 215 of the front axle 205 go into significant slip 262. An immediate reduction in the brake pressure 420 then takes place through a pressure release. However, the utility vehicle 200b exhibits an axle load transfer 272 due to the chassis of the utility vehicle 200b. Therefore, due to a decrease in the normal force FN on the wheels 215 of the front axle 205, for example, a reduction in pressure is barely able to prevent significant wheel slip.

FIG. 4 shows a time series 400 in each case of wheel speeds 410 and brake pressures 420 and of a control signal 280 of a utility vehicle 200b according to one embodiment of the present disclosure. Such a vehicle 200b is described with reference to FIGS. 1 and 2. FIG. 4 is described with reference to FIGS. 1 to 3. The differences between the time series of FIGS. 3 and 4 are described here. The indexing of the time series 400 of FIGS. 3 and 4 is identical here.

In contrast to FIG. 3, FIG. 4 has a third part. By way of example, a control signal 280 is shown below the brake pressures 420. The control signal 280 is in binary form here. A lower value (zero) indicates here that the service brake 210 may be controlled as in the prior art. An upper value (one) indicates that the control signal 280 is applied to the service brake 210 and the service brake 210 is controlled according to the method 100 according to FIG. 2.

It can be seen from the brake pressures 420 that the control signal 280 is output such that the brake pressures 420 at the wheels 215 of the front axle 205 are reduced and are then maintained, whilst a loss of traction is observed at the rear axle 205′.

From the wheel speeds 410, FIG. 4 shows a considerable improvement in the slip 262 of each of the wheels 215, 215′ compared to FIG. 3. The wheels 215, 215′ exhibit barely any critical slip 262. An occupant of the vehicle 200a, 200b may establish- and it may be established via measurements-that a vibrating movement 201 of the vehicle 200a, 200b is suppressed and the vehicle 200a, 200b no longer rocks since an axle load transfer 272 and/or a vibrating mode of the vehicle 200a, 200b may be suppressed.

### REFERENCE SIGNS (PART OF THE DESCRIPTION)

100 Method
110 Record
120 Ascertain
130 Output
200a Vehicle
200b Utility vehicle
201 Vibrating behavior
205, 205′ Axle
210 Service brake
211, 211′ Braking variable
215, 215′ Wheel
220 Anti-lock braking system
250 Control unit
260 Input variable
262 Slip
264 Wheel deceleration
270 Control variable
272 Axle load transfer
275 Vehicle reference speed
280 Control signal
300 Ground
400 Time series
410 Wheel speed
411 Vehicle speed
420 Brake pressure
t Time
FN Normal force
MU, MU′ Friction coefficient

1. A method (100) for operating a service brake (210) in relation to an axle (205) in order to brake a wheel (215) of an axle (205) of a vehicle (200a) having a further axle (205′) which is different from the axle (205), wherein the method (100) comprises:
recording (110) an input variable (260) relating to the further axle (205′);
ascertaining (120) a control variable (270) relating to the axle on the basis of the input variable (260) relating to the further axle (205′); and
outputting (130) a control signal (280) for changing a braking variable (211) of the service brake (210), taking into account the control variable (270) relating to the axle.

2. The method (100) as claimed in claim 1,
wherein the service brake (210) comprises an anti-lock braking system (220) and the input variable (260) indicates whether an ABS control (221) of the service brake (210) is taking place,
wherein the input variable (260) comprises a slip (262) of the wheel (215′) of the further axle (205′), a wheel deceleration (264) of the wheel (215′) of the further axle (205′), and/or a control signal for controlling a braking variable (211′) for braking the wheel (215′) of the further axle (205′).

3. The method (100) as claimed in claim 1, wherein the control signal (280) is output such that the braking variable (211) remains constant or decreases when a normal force (FN) acting on the wheel (215′) of the further axle drops, and the braking variable (211) increases when a normal force (FN) acting on the wheel (215′) of the further axle (205′) rises.

4. The method (100) as claimed in claim 1, wherein a vibrating behavior (201) and an axle load transfer (272) of the vehicle (200a) is ascertained on the basis of the input variable (260), and wherein the control variable (270) is ascertained taking into account the vibrating behavior (201) and the axle load transfer (272).

5. The method (100) as claimed in claim 1, wherein the input variable (260) comprises a friction coefficient (MU′) between the wheel (215′) of the further axle (205′) and the ground (300).

6. The method (100) as claimed in claim 5, wherein the control variable (270) includes a difference between the friction coefficient (MU′) between the wheel (215′) of the further axle (205′) and the ground (300) and a friction coefficient (MU) between the wheel (215) of the axle (205) and the ground (300).

7. The method (100) as claimed in claim 6, wherein the control variable (270) includes a prediction of a friction coefficient (MU) between the wheel (215) of the axle (205) and the ground (300).

8. A non-transitory computer-readable medium, comprising commands which, when the commands are executed by a computer, cause the computer to carry out the method (100) according to claim 1.

9. A control unit (250) for a vehicle (200a), wherein the control unit (250) is designed to carry out the method (100) as claimed in claim 1.

10. A vehicle (200a) comprising a service brake (210) having an anti-lock braking system (220) and the control unit (250) as claimed in claim 9.

11. The method as claimed in claim 1, wherein the axle is a rear axle and the further axle is a front axle.

12. The method as claimed in claim 1, wherein the input variable relating to the further axle is an input variable external to the axle.

13. The method as claimed in claim 11, wherein the method detects a μ-jump scenario including a transition of the road surface having a reduction in traction on the front axle to control braking at the rear axle as a preventative measure.

14. The method (100) as claimed in claim 5, wherein the control variable (270) includes a prediction of a friction coefficient (MU) between the wheel (215) of the axle (205) and the ground (300).

15. The method (100) as claimed in claim 2, wherein the control signal (280) is output such that the braking variable (211) remains constant or decreases when a normal force (FN) acting on the wheel (215′) of the further axle drops, and the braking variable (211) increases when a normal force (FN) acting on the wheel (215′) of the further axle (205′) rises.

16. The method (100) as claimed in claim 15, wherein a vibrating behavior (201) and an axle load transfer (272) of the vehicle (200a) is ascertained on the basis of the input variable (260), and wherein the control variable (270) is ascertained taking into account the vibrating behavior (201) and the axle load transfer (272).

17. The method (100) as claimed in claim 16, wherein the input variable (260) comprises a friction coefficient (MU′) between the wheel (215′) of the further axle (205′) and the ground (300).

18. The method (100) as claimed in claim 17, wherein the control variable (270) includes a difference between the friction coefficient (MU′) between the wheel (215′) of the further axle (205′) and the ground (300) and a friction coefficient (MU) between the wheel (215) of the axle (205) and the ground (300).

19. The method (100) as claimed in claim 18, wherein the control variable (270) includes a prediction of a friction coefficient (MU) between the wheel (215) of the axle (205) and the ground (300).

20. The method as claimed in claim 19, wherein the axle is a rear axle and the further axle is a front axle.
